(19) United States
(12) Patent Application Publication
(10) Pub. No.: US 2026/0226993 A1
(43) Pub. Date: Aug. 6, 2026

(54) PIEZOELECTRIC VALVE

(71) Applicant: CAMOZZI AUTOMATION S.P.A., Milano (IT)

(72) Inventors: Michele GATTI, Milano (IT); Marco ROSSI, Milano (IT); Alberto MINGOTTI, Milano (IT); Dario FERRARINI, Milano (IT); Davide CARATI, Castel San Pietro Terme (Bologna) (IT); Marco FARETRA, Longiano (Forlì-Cesena) (IT)

(21) Appl. No.: 19/151,819

(22) PCT Filed: Feb. 20, 2024
(86) PCT No.: PCT/IB2024/051590

§ 371 Date: Jul. 29, 2025

(30) Foreign Application Priority Data
Feb. 21, 2023 (IT) 102023000002931

(51) Int. Cl. F16K 31/00

(52) U.S. Cl. CPC F16K 31/006

(57) ABSTRACT

A piezoelectric valve has a valve body having an inlet duct for a pressurized fluid, an outlet duct for the pressurized fluid, and a valve seat that puts the inlet duct and the outlet duct in fluid communication. The piezoelectric valve is further provided with a piezoelectric plate. An inner chamber is provided within the valve body. A sealing membrane is housed in the inner chamber. The sealing membrane has a shutter portion facing the valve seat. The piezoelectric plate has a distal plate portion operatively connected to the sealing membrane by at least one rigid force transfer element, optionally the at least one rigid force transfer element being a sphere.

The present invention is in relation to piezoelectric valves wherein the flow if a fluid circulating within the valve is controlled by means of the movement of a flow control element driven by a piezoelectric actuator.

Piezoelectric valves are known that comprise a valve body having an inlet duct for a pressurized fluid, a fluid outlet duct, and a valve seat which puts the inlet duct and the outlet duct in fluid communication. Housed within the valve body is a piezoelectric plate which is suitable for deforming when it is electrically actuated in order to engage and disengage with the valve seat in such a way as to adjust the flow of fluid through such valve seat.

Examples of such valves are described within the documents DE102018219017, DE102016213228, DE19957953, WO2009/010117.

The object of the present invention is that of proposing a piezoelectric valve of the type described above that is capable of offering improved performance, both in terms of adjusting the flow of fluid and in terms of electricity consumption.

A further scope of the invention is that of making available a piezoelectric valve of particularly reduced dimensions.

A further object of the invention is that of proposing a piezoelectric valve that is particularly suitable for being engaged in applications that require that the fluid flowing through the valve should not be contaminated, for example in the medical or food sectors.

Such objects are achieved with a piezoelectric valve according to claim 1. The dependent claims describe preferred or advantageous embodiments of the piezoelectric valve.

The features and the advantages of the piezoelectric valve according to the invention shall be made readily apparent from the following description of preferred embodiments thereof, provided purely by way of a non-limiting example, with reference to the accompanying figures, wherein:

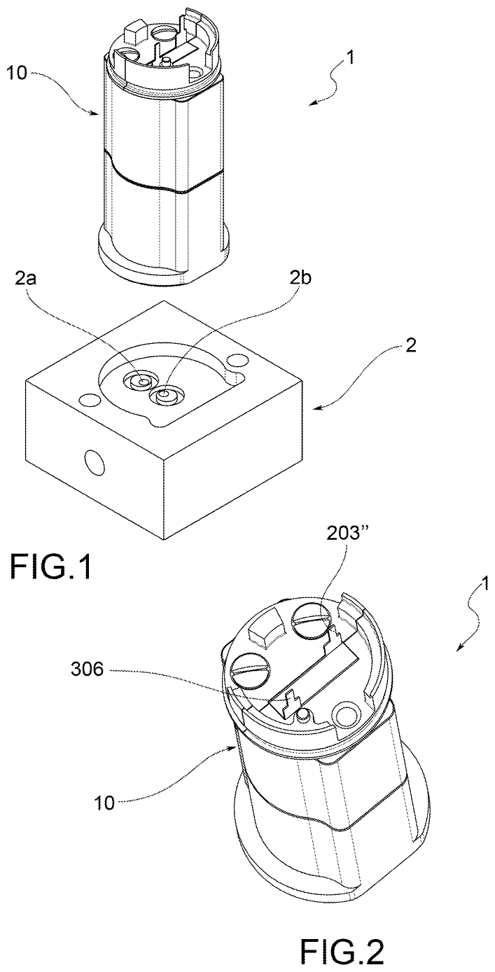

FIG. 1 is a perspective view of the piezoelectric valve;

FIG. 2 is a perspective view of the valve from above;

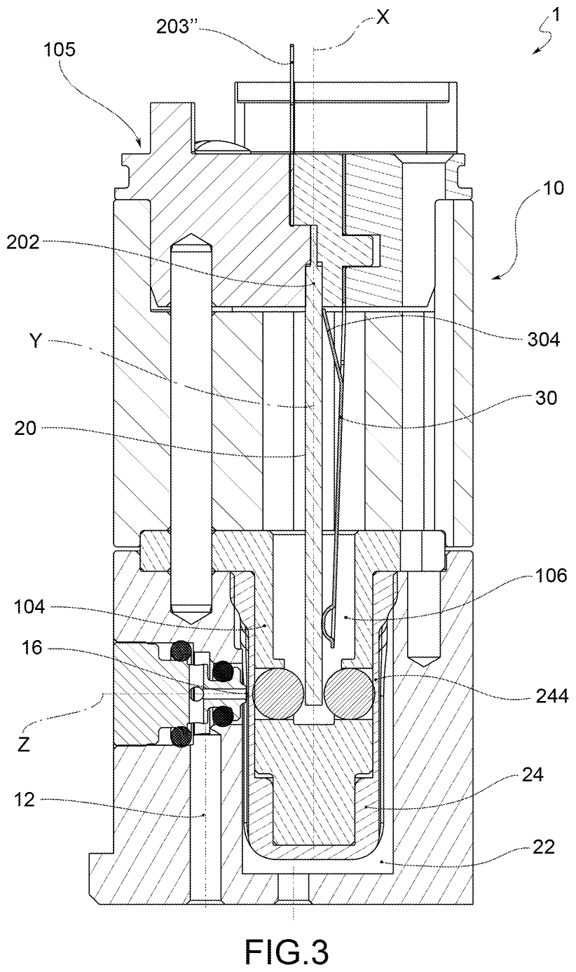

FIG. 3 is an axial cross-section of the valve;

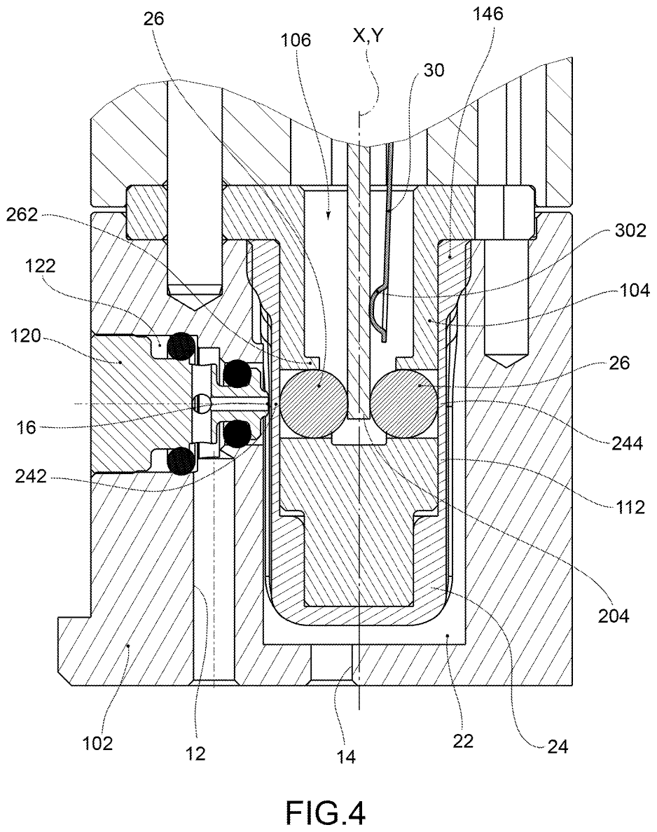

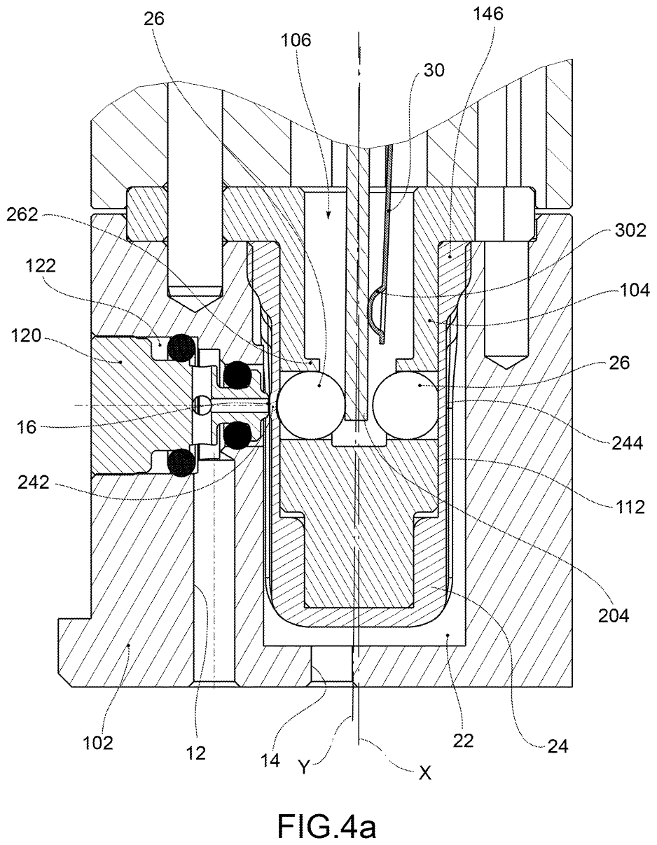

FIGS. 4 and 4a are two enlarged views of the lower portion of the valve, in a valve open and a valve closed configuration respectively;

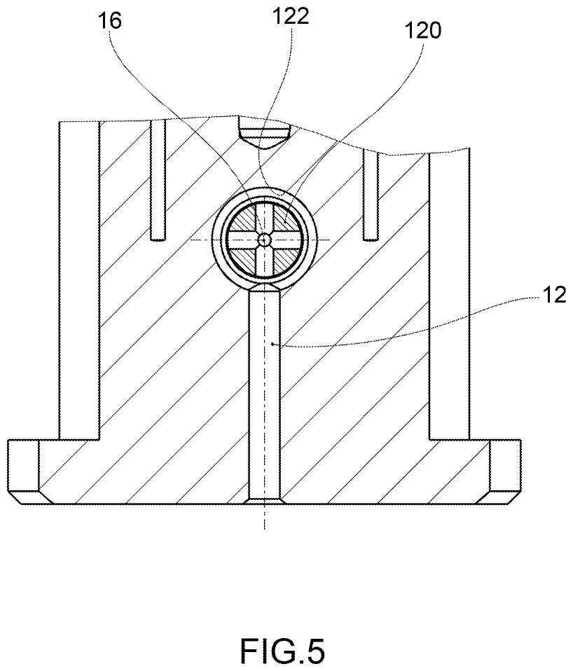

FIG. 5 is an axial cross-section of the lower portion of the valve at the nozzle that forms the valve seat;

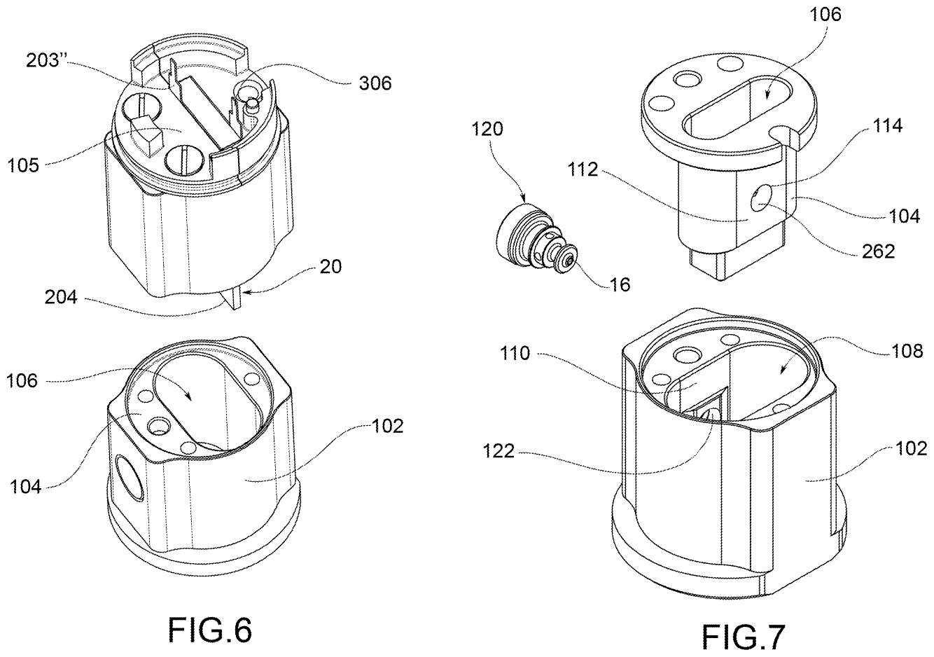

FIG. 6 is a perspective view in separate parts of the piezoelectric valve;

FIG. 7 is a perspective view in separate parts of a lower portion of the valve body; and

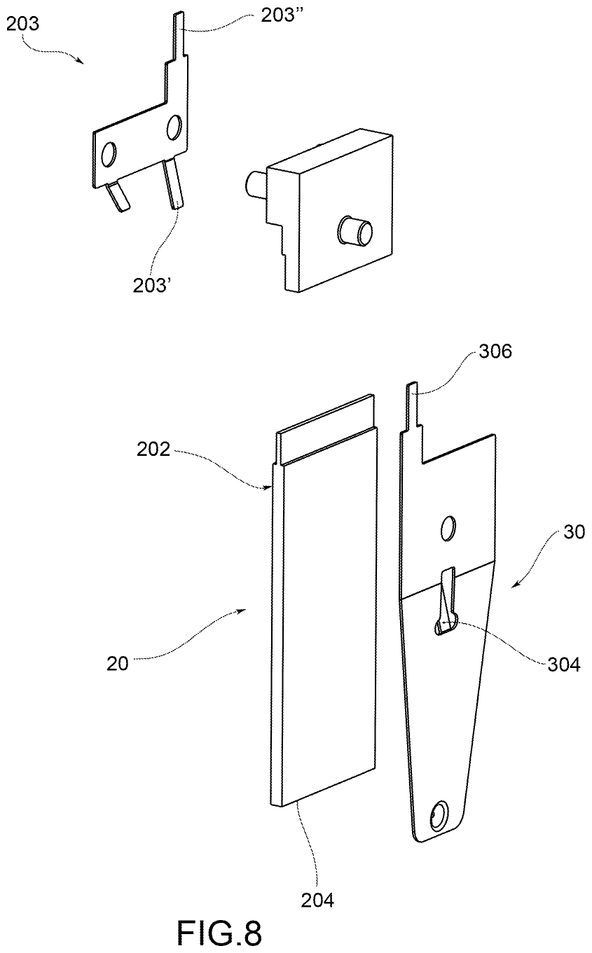

FIG. 8 is a perspective view in separate parts of the piezoelectric plate and of the pusher spring element associated thereto.

In said drawings, the reference numeral 1 indicates a piezoelectric valve according to the invention in the entirety thereof.

The piezoelectric valve 1 comprises a valve body 10 that forms an inlet duct 12 for a pressurized fluid and an outlet duct 14 for the pressurized fluid. A valve seat 16 is obtained in, or inserted into, the valve body 10, the valve seat 16 puts the inlet duct 12 and the outlet duct 14 in fluidic communication.

In one embodiment, the valve body 10 has a prismatic shape and extends predominantly along a main body axis X that, in the example shown, is a vertical axis.

In the remainder of this description, terms such as “upper,” “lower,” or synonyms thereof, will therefore be used with reference to the example shown in the drawings, wherein the piezoelectric valve 1 is arranged with a predominantly vertical extension.

In one embodiment, the valve body 10 may be assembled on a base 2 wherein at least two ducts 2a, 2b are obtained, for example for feeding and discharging, that are suitable for being put in fluid communication with the inlet duct 12 and the outlet duct 14.

Within valve body 10 a piezoelectric plate 20 is housed, the piezoelectric plate 20 being suitable for deforming when it is electrically actuated. As will be described in more detail hereinafter, the piezoelectric plate 20 is actuatable by means of a difference in electrical voltage in such a way as to provoke the opening and closing of the valve seat 16 so as to adjust the flow of fluid within the valve.

In one embodiment, the piezoelectric plate 20 predominantly extends along a plate axis Y, parallel to, or coincident with, the main body axis X.

The piezoelectric plate 20 terminates with a distal plate portion 204. Following the electrical actuation of the piezoelectric plate 20, the distal plate portion 204 moves along a direction that is substantially orthogonal to the plate axis Y.

Furthermore, within the valve body 10 an inner chamber 22 is obtained. Such inner chamber 22 communicates with the valve seat 16 and with the outlet duct 14. Therefore, the inner chamber 22 is suitable for being filled with fluid when the valve seat 16 is (at least partially) open.

Within the inner chamber 22 a sealing membrane 24 is housed, the sealing membrane 24 functioning both as a means of separation between the fluid circulating within the valve and the piezoelectric plate 20, and as a shutter element of the valve seat 16.

In more detail, the sealing membrane 24 has a shutter portion 242 facing the valve seat 16. The sealing membrane 24 is furthermore at least partially arranged about the piezoelectric plate 20 so as to avoid contact between the piezoelectric plate 20 and the fluid circulating in the valve.

The distal portion 204 of the piezoelectric plate 20 is operatively connected to the sealing membrane 24 by means of at least one rigid force transfer element 26.

Therefore, the distal portion 204 of the plate is movable between a first position, in which it causes, by means of the at least one rigid element 26, a deformation of at least said shutter portion 242 of the sealing membrane 24 to close the valve seat 16 (FIG. 4a), and a second position, in which it allows the at least said shutter portion 242 to remain in an undeformed state in which it is detached from the valve seat 16 (FIG. 4). In said second position the valve seat 16 is therefore open.

Note that the piezoelectric valve 1 may function both as an on-off valve in order to enable or block fluid flow through the valve seat 16 and as a proportional valve for adjusting the fluid flow. In such second case, in fact, in modulating the intensity of the difference in electrical voltage applied to the piezoelectric plate 20, it is possible to adjust the excursion of the distal portion 204 of the plate accordingly and therefore the deformation of the shutter portion 242 of the sealing membrane 24. In other words, the shutter portion 242 may assume a maximum deformation configuration, wherein it sealingly closes the valve seat 16, and an undeformed configuration, wherein it completely opens the valve seat 16, and intermediate deformation configurations, wherein it adjusts the flow of fluid passing through the valve seat 16.

In one embodiment, the piezoelectric valve 1 furthermore comprises a pusher spring element 30 cooperating with the piezoelectric plate 20.

In detail, when the piezoelectric plate 20 is not electrically actuated, the distal portion 204 of the plate is biased by the pusher spring element 30 to remain in the first position, wherein the valve seat 16 is completely sealingly closed by the shutter portion 242 of the sealing membrane 24.

When the piezoelectric plate 20 is electrically actuated, the distal portion 204 of the plate switches from the first position to the second position (or, in the case of a proportional valve, to an intermediate position) overcoming the force of the pusher spring element 30.

In one embodiment variation, the functioning of the piezoelectric valve may be the opposite. As a matter of fact, when the piezoelectric plate 20 is not electrically actuated, the distal plate portion 204 may be biased by a pusher spring element 30 to remain in the second position, in which the valve seat 16 is completely open; vice versa when the piezoelectric plate 20 is electrically actuated, the distal plate portion 204 switches from the second position to the first position (or, in the case of a proportional valve, to an intermediate position) overcoming the force of the pusher spring element 30.

In one embodiment, the distal portion 204 of the plate is positioned between two rigid force transfer elements 26 being equal to each other and engaging two respective opposite portions of the sealing membrane 24, i.e., the shutter portion 242 and an opposite portion 244. In this way, when the distal plate portion 204 is in the second position, the resultant of the forces exerted by the pressurized fluid present in the inner chamber 22 onto the distal portion 204 of the plate is substantially zero. In this situation, therefore, the piezoelectric plate 20 must be electrically driven in order to only overcome the force of the pusher spring element 30, and not also the pressure exerted by the fluid.

In one embodiment, the at least one rigid force transfer element 26 is a sphere positioned with possibility of translation between the distal plate portion 204 and the shutter portion 242 of the sealing membrane 24.

In one embodiment, the rigid force transfer element 26 is housed within a guide seat 262 obtained or inserted into the valve body 10.

In the embodiment shown, the distal plate portion 202 is inserted between two spheres 26, each engaging a respective portion 242, 244 of the sealing membrane. The spheres 26 and the portions 242, 244 of the sealing membrane 24 are arranged in a substantially mirroring manner in relation to the plate axis Y.

In one embodiment, the inlet duct 12 and outlet duct 14 and the valve seat 16 are obtained or comprised in an outer portion 102 of the valve body 10, for example an outer portion that also forms the base of the valve body 10.

The distal portion 204 of the plate is housed within an inner portion 104 of the valve body 10 forming, with the outer portion 102, the inner chamber 22. The distal plate portion 204, and the pusher spring element 30, where present, extend axially within a plate chamber 106 obtained within the inner portion 104.

Within the inner portion 104 of the valve body 10 the guide seat 262 is obtained or housed for the at least one rigid force transfer element 26. The sealing membrane 24 is sealingly fit and with shape coupling onto said inner portion 104 of the valve body 10.

For example, the outer portion 102 has a glass shape wherein an inner cavity 108 is formed.

Such inner cavity 108 is delimited by a side wall 110.

In one embodiment, the inner portion 104 forms at least one flat wall 112 (two flat walls that are opposite and parallel therebetween in the example shown). The at least one flat wall 112 faces the valve seat 16. Within the at least one flat wall 112, preferably within the pair of opposing flat walls 112, an opening 114 is obtained, that forms or wherein the guide seat 262 is obtained that places the inner chamber 22 in communication with the plate chamber 106. The rigid force transfer element 26 may protrude from the opening 114 facing the valve seat 16 to deform the shutter portion 242 of the sealing membrane 24.

The sealing membrane 24, in one embodiment, has a cup shape. The sealing membrane 24 may furthermore be locked in position by means of one thickened upper edge 146 thereof that is retained between the side wall of the inner portion 104 and the facing side wall of the outer portion 102 that delimits the inner cavity 108.

In one embodiment, the valve seat 26 is obtained at the end of a nozzle 120 sealingly inserted into a nozzle seat 122 obtained in the valve body 10, for example within the outer portion 102 of the valve body 10. Such nozzle seat 122 fluidically communicates with the inlet duct 12 and the inner chamber 22.

In one embodiment, the nozzle 120 and the valve seat 26 extend around a nozzle axis Z perpendicular to the plate axis Y.

In one embodiment, the nozzle seat 122 is furthermore externally open and makes it possible to adjust the insertion depth of the nozzle 120 into the nozzle seat 122, so as to adjust the distance between the valve seat 16 and the shutter portion 242 of the sealing membrane 24 and therefore the fluid flowing out from the valve seat when the shutter portion 242 is in the deformed position.

Turning to the pusher spring element 30, in one embodiment, it is made using a flexural spring extending alongside the piezoelectric plate 20 and the distal end 302 of which, provided for example with a spherical protrusion, engages with the distal plate portion 204.

In one embodiment, the pusher spring element 30 is made of electrically conductive material and is electrically connected to the piezoelectric plate 20, for example by means of an electrical connection tab 304.

In one embodiment, as a matter of fact, the piezoelectric plate 20 has a first pole electrically connected to a first supply terminal 203, which, for example, is made by an electrical contact having at least one blade 203′ arranged in contact with such first pole, and a second pole electrically connected, for example by means of the electrical connection tab 304, to the pusher spring element 30, which therefore also serves as second supply terminal.

For example, the first supply terminal 203 and the pusher spring element 30 have respective appendages 203″, 306, that protrude, for example above, from the valve body 10.

In one embodiment, the proximal end portion 202 of the piezoelectric plate 20 and the pusher spring element 30 are attached to the valve body 10 in being stably retained by the geometric coupling between the complementary parts of an upper portion 105 of the valve body 10. This enables rapid and easy assembly of the valve body, of the piezoelectric plate using the relative electrical contacts and of the pusher spring element.

It is evident from the above that the proposed piezoelectric valve enables the achievement of the intended objectives.

In particular, the fluid flow adjustment is obtained in a highly precise and reliable manner by virtue of the transformation of the deformation of the piezoelectric plate into a translation of the rigid force transfer element which acts upon the sealing membrane.

The use of the sphere as a rigid force transfer element makes it possible, furthermore, to implement a deformation of the shutter portion of the sealing membrane that is particularly suitable for ensuring hermetic closing of the valve seat.

The use of the sealing membrane, furthermore, prevents any contact between the fluidic part of the valve and the piezoelectric actuation part, thereby making the valve suitable for applications where the absence is requested of impurities within the fluid that circulates within the valve.

The presence of an inner chamber 22 that surrounds the sealing membrane 24, which acts upon the piezoelectric plate 20 by means of the rigid force transfer elements 26 arranged in a mirroring manner in relation to the plate, makes it possible to minimize the forces that insist upon the plate when the valve seat is open and there is pressurized fluid within the inner chamber 22.

A person skilled in the art may make several changes, adjustments, adaptations and replacements of elements with others that are functionally equivalent to the embodiments ; of the piezoelectric valve according to the invention in order to meet incidental needs, without departing from the scope of the following claims. Each of the features described as belonging to a possible embodiment may be obtained independently of the other described embodiments.

1. A piezoelectric valve, comprising:
a valve body comprising an inlet duct for a pressurized fluid, an outlet duct for the pressurized fluid, and a valve seat that puts the inlet duct and the outlet duct in fluid communication; and
a piezoelectric plate, suitable for deforming when electrically actuated, housed in the valve body;
wherein:
an inner chamber communicating with the valve seat and the outlet duct is provided in the valve body;
a sealing membrane is housed in the inner chamber, the sealing membrane having a shutter portion facing the valve seat and being at least partially arranged about the piezoelectric plate so as to avoid contact between the piezoelectric plate and the pressurized fluid circulating in the piezoelectric valve;
the piezoelectric plate has a distal plate portion operatively connected to the sealing membrane by at least one rigid force transfer element, the distal plate portion being movable between a first position, in which the distal plate portion causes, by the at least one rigid force transfer element, a deformation of at least the shutter portion of the sealing membrane to close the valve seat, and a second position, in which the distal plate portion allows at least the shutter portion to remain in an undeformed state in which the shutter portion is detached from the valve seat.

2. The piezoelectric valve of claim 1, wherein, when the piezoelectric plate is not electrically actuated, the distal plate portion is biased by a pusher spring element to remain in the first position, and wherein, when the piezoelectric plate is electrically actuated, the distal plate portion switches from the first position to the second position, overcoming a force of the pusher spring element.

3. The piezoelectric valve of claim 1, wherein the distal plate portion is positioned between two rigid force transfer elements equal to each other and engaging two respective opposite portions of the sealing membrane, so that, when the distal plate portion is in the second position, a resultant of forces exerted by the pressurized fluid present in the inner chamber onto the distal plate portion is substantially zero.

4. The piezoelectric valve of claim 1, wherein the at least one rigid force transfer element is a sphere positioned with possibility of translation between the distal plate portion and the shutter portion of the sealing membrane.

5. The piezoelectric valve of claim 1, wherein the inlet and outlet ducts and the valve seat are obtained or included in an outer portion of the valve body, wherein the distal plate portion is housed in an inner portion of the valve body forming, with the outer portion, the inner chamber, wherein at least one element seat is obtained or housed within the piezoelectric valve, wherein the at least one rigid force transfer element is received with possibility of translation in the at least one element seat, and wherein the sealing membrane is sealingly fit with shape coupling onto said the inner portion of the valve body.

6. The piezoelectric valve of claim 1, wherein the valve seat is obtained at an end of a nozzle sealingly inserted into a nozzle seat provided in the valve body and fluidically communicating with the inlet duct and the inner chamber.

7. The piezoelectric valve of claim 2, wherein the pusher spring element is a flexural spring extending alongside the piezoelectric plate and a distal end of the flexural spring engages the distal plate portion.

8. The piezoelectric valve of claim 7, wherein the pusher spring element is made of an electrically conductive material and is electrically connected to a pole of the piezoelectric plate.
